(19) United States
(12) Patent Application Publication
(10) Pub. No.: US 2008/0067754 A1
(43) Pub. Date: Mar. 20, 2008

(54) PRESSURE GRADIENT ROTARY SEALING SYSTEM WITH EXTERNAL PISTON

(76) Inventors: John Schroeder, Orange, CA (US); William Brustad, Perris, CA (US); Sanford Damasco, Irvine, CA (US); Jack Bunn, Houma, LA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/676,454

(22) Filed: Feb. 19, 2007

Related U.S. Application Data
(63) Continuation-in-part of application No. 11/532,014, filed on Sep. 14, 2006.

(51) Int. Cl. F16J 15/50

(52) U.S. Cl. 277/437

(57) ABSTRACT

A pressure gradient rotary sealing system is described with an additional configuration which uses and externally mounted pressure-reducing piston with a differential area to create a pressure differential across the system to reduce the pressure×velocity (PV) value to extend seal system life and provide early indication of impending seal failure. This invention is another embodiment of this previous invention offering using a separate externally mounted pressure reducing piston therefore the main body of the wash-pipe top-nut is lighter weight, the system has more fluid capacity, is simpler to assemble, operate and monitor and has a longer service life than previous configurations.

The present application is a continuation-in-part of U.S. Ser. No. 11/532,014 filed Sep. 14, 2006.

The present invention generally relates to a rotary seal that is used in a high speed, high pressure, high temperature environment where seal life and seal life predictability are very important. A more specific and typical application is with a wash pipe used in a drilling rig where a seal failure requires system shutdown. Seal life is a function of wear. The lower the pressure velocity (PV) value, the longer the seal life. PV is seal contact pressure multiplied by the velocity for a rotary seal. At high pressures the seals are energized by the operating pressure. This invention provides for increasing seal life by the use of multiple tandem mounted seals and reducing the pressure (i.e. PV values) sequentially for each seal. The invention configuration provides for detecting incipient seal failure so that otherwise required and untimely maintenance shutdown can anticipate and schedule as routine maintenance.

### SUMMARY OF THE INVENTION

A pressure differential sealing system in accordance with this invention for providing sealing between a rotating member and a stationary member that includes an excluder seal and one or more pressure-reduction pistons that are used to reduce the pressure between sealing stages. The sealing system is lubricated by grease packs. The excluder seal is designed to protect the sealing system from the media, which in the case of drilling operations can be very abrasive and under pressures as high as 7500 lb/square inch and temperatures as high as 360 Fahrenheit. The excluder seal isolates the rest of the sealing system from the media. The subsequent seals in the system are exposed only to the grease pack and are lubricated by the grease pack which results in lower friction and longer seal life.

A floating pressure-reducing piston reduces the pressure drop across one or more sequential sealing stages and thus each seal in those stages experiences a lower PV thereby increasing seal life. The pressure-reducing piston has an area differential between two ends of the piston to produce the pressure drop.

The rear seals have metal retaining rings to prevent rotation and provide retention. All seals in the system are energized by canted coil springs and by the media pressure. A canted coil retaining spring is provided to retain the sealing system in place during assembly.

The grease packs have pressure monitors. Under normal operation, the system will have a standard pressure differential. As the sealing system wears to the extent that fluid leakage into the system is encountered, that pressure differential will be reduced. This reduced pressure differential provides an early indication of seal wear and thus system shutdown for maintenance can be scheduled instead of having an unplanned event.

Various embodiments of the present invention include the following:

A) The seals can be arranged sequentially, in tandem and coaxial about the rotating shaft (see FIGS. 2a and 2b); in such case using first a balanced-pressure floating-excluder seal, next the pressure reducing step-piston, and then two tandem rotary pressure seals.

B) The seals can be arranged sequentially in tandem about the rotating shaft (FIGS. 3a and 3b), in such case using first a balanced-pressure floating-excluder seal, next two sequential pressure reducing step-piston arrangements, and then two tandem rotary pressure seals.

C) The seals can be arranged sequentially in tandem about the rotating shaft (FIGS. 4a and 4b), in such case using first a balanced-pressure floating-excluder seal, and then two tandem rotary pressure seals, and the pressure reducing piston are arranged as three or more small pressure-step pistons located around the circumference and ported so as to decrease the system pressure to each successive level of pressure seals.

D) The seals can be arranged sequentially in tandem about the rotating shaft (FIGS. 5a and 5b), in such case using first a balanced-pressure floating-excluder seal, and then two tandem rotary pressure seals, and the pressure reducing piston are arranged as a larger piston located concentrically about the fluid seal system, ported so as to decrease the system pressure to each successive level of pressure seals.

E) Seals can also be arranged sequentially in tandem about the rotating shaft, in such case using first a balanced-pressure floating-excluder seal, and then two tandem rotary pressure seals, and the pressure reducing pistons are arranged as three or more small pressure-step pistons located around the circumference and ported so as to decrease the system pressure to each successive level of pressure seals, and in this case, two stages of pressure reducing pistons are used.

F) A pressure reducing piston assembly may be connected external to the wash-pin assembly. This embodiment offers the following benefits:
1. The wash-pipe main nut body is smaller and lighter weight because this improvement eliminates the need to accommodate internal space for the built-in pressure reducing pistons of the previous configurations. This smaller and lighter weight embodiment is a significant convenience since these units are typically installed manually under severe and difficult conditions in the field.
2. The externally mounted pressure reducing piston is larger in size and therefore provide additional fluid capacity; therefore increasing the service life and time-between-maintenance intervals.
3. The externally mounted pressure reducing piston is visible as to the position of the piston compared with the previous described internally mounted piston configurations. This visibility allows easy visual or remote monitoring of the piston-position in order to better predict when the system will need servicing, and hence avoid any unscheduled and costly process shut-downs.
4. The assembly procedure using the externally mounted pressure reducing piston is significantly simplified since this new design has only one piston to set-up and maintain (which is properly sized to contain the desired fluid volume displacement). The previous design required three or more internal pistons in order to have enough fluid volume, which were then significantly more complex and difficult to assemble, set-up, and maintain.

### BRIEF DESCRIPTION OF THE DRAWINGS

The present invention may be more clearly understood with reference to the following detailed description when taken in conjunction with the appended drawings, in which:

FIG. 1 is an elevation view illustrating a wash pipe and a system in accordance with the present invention for providing sealing between a rotatable conduit and a stationary member;

FIGS. 2a and 2b shows one embodiment of the present invention utilizing a single pressure reducing piston;

FIG. 3a and 3b shows another embodiment of the present invention similar to that shown in FIG. 2a, but with two pressure reductions stages;

FIG. 4a and 4b show a pressure gradient sealing system in accordance with the present invention with one or more side mounted pressure reducing pistons;

FIGS. 5a and 5b show a pressure gradient rotary sealing system in accordance with the present invention utilizing annular ring pressure-reducing piston;

FIG. 6 is yet another embodiment of the present invention utilizing an external pressure reducing piston.

### DETAILED DESCRIPTION

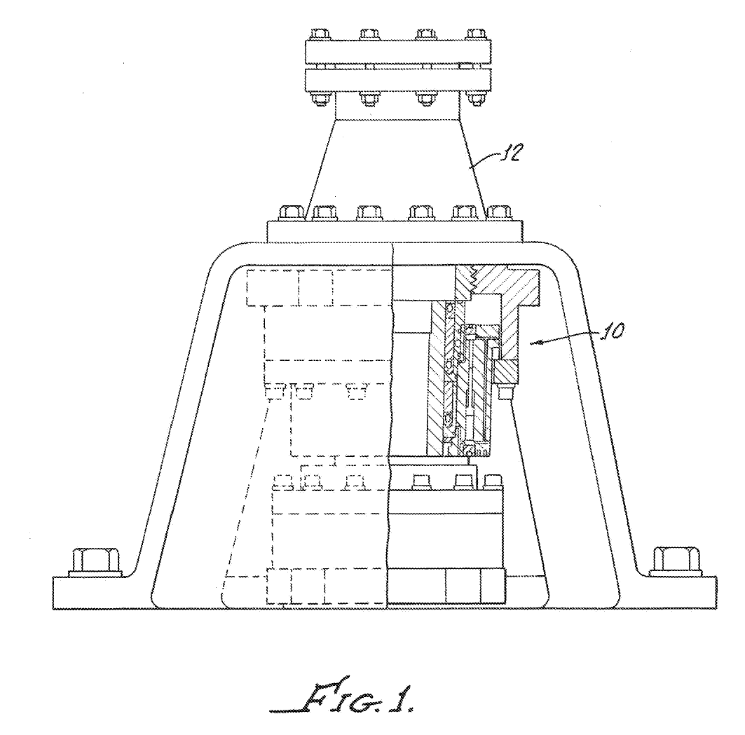

With reference to FIG. 1, there is shown a pressure gradient sealing system 10 as it may be installed on an oil rig top drive 12.

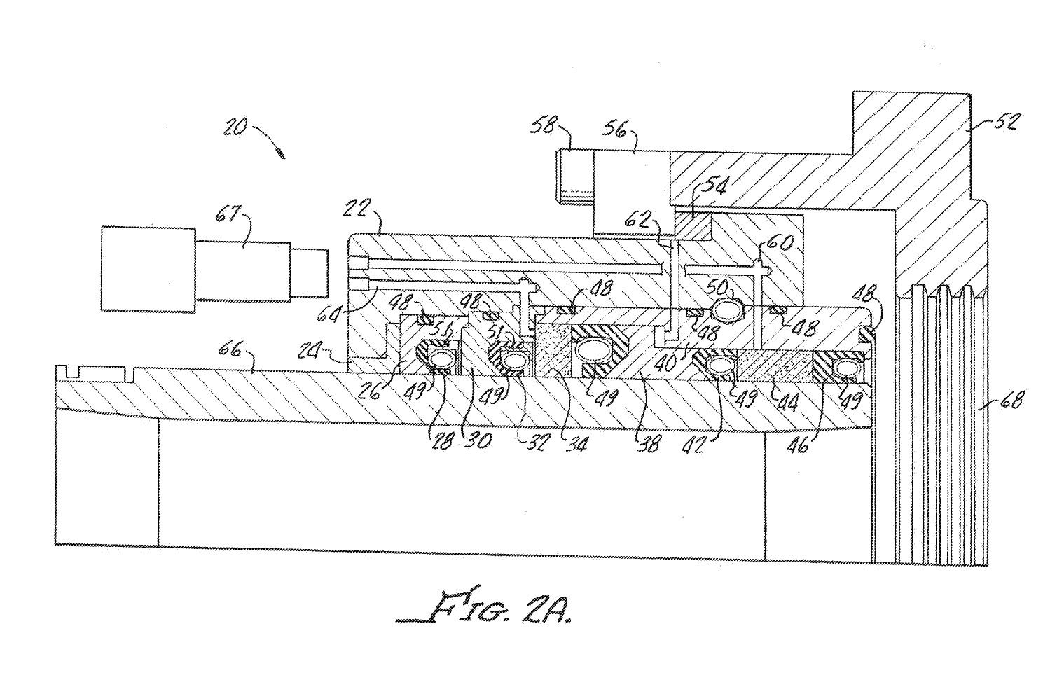

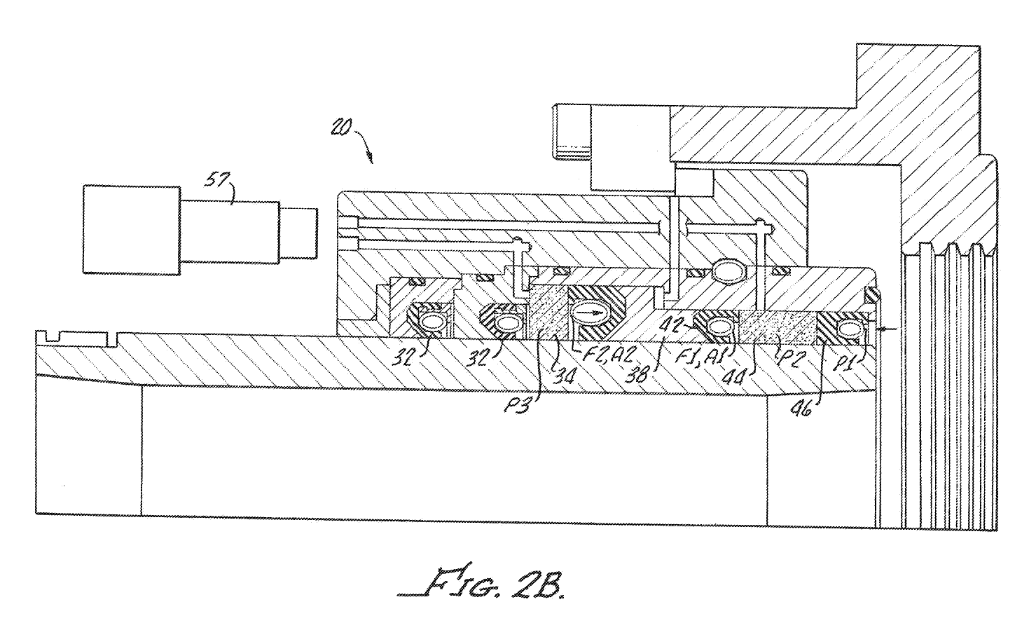

Embodiment 20 for a sealing system in accordance with the present invention as shown in FIG. 2a generally includes a rear sealing system cartridge housing 22, a sealing assembly guide bushing 24, a rear fixed seal housing 26, a rear fixed seal 28; a front fixed seal housing 30 and a front fixed seal 32, the fixed seal 28 being disposed proximate an atmosphere pressure end of the system 20.

A rear grease pack 34 is provided along with a rear seal 36 abutting a floating pressure reducing piston 38.

A front sealing cartridge housing 40 is provided along with a front piston seal 42 for the floating pressure reducing piston 38.

A front grease pack 44 is disposed between the front seal 42 and a floating pressure-balanced excluder seal 46. As will be described hereinafter in greater detail the system 20 also includes a plurality of static system O-rings 48 and all of the seals utilized canted coil springs 49 and seals 28, 32 include metal retaining rings 51.

A cartridge assembly canted coil spring 50 is shown along with a threaded ring 52, a tightening washer 54, locking ring 56, and locking bolt 58.

A front pressure port 60 is provided and interconnected with the front grease pack 44 along with a middle pressure port 62 and an rear pressure port 64 interconnected with the rear grease pack 34.

The threaded ring 52 is coupled into a wash pipe tube 66 via threads 68, the tube 66 having drilling mud (not shown) flowing inside at high pressure. Drilling mud is usually a mixture of clay chemicals and water or oil and thus is an abrasive slurry.

The sealing system in accordance with the present invention has several functions in order to accomplish extended seal life.
1. First, the seal system 20 isolates the harsh abrasive media by utilizing the floating pressure-balanced excluder seal 46. The subsequent seals 28, 32, 42 in the system 20 are exposed only to the grease pack 34,44 fluid, which is a design benefit because this provides lower friction and longer seal life.
2. The fluid sealing system effectively reduces the pressure across one or more sequential sealing zones in a state of force-equilibrium, therefore each seal experiences a lower PV and increasing the life of the sealing system. This is accomplished by the floating pressure reducing piston 38 having a smaller area on the energizing end. The pressure transferred is lower in direct proportion to the projected area differential of each end of the pistons 38.
3. The seals 28, 32 support the remaining pressure differential with a tandem seal combination. This redundant seal provided added life to the sealing system.
4. The seals 28, 32 are mounted with metal retaining rings 51 to help prevent rotation in the housings 26, 30, and to prevent OD shrinkage upon after a high temperature cycle.
5. All the seals utilize a filled polymer or PTFE material, which has lower friction, and can withstand higher temperatures that typical elastomers.
6. The polymer seals are energized with the canted coil spring technology to better energize the seals to close the seal gap after seal wear occurs, to ensure proper energizing with the media pressure.
7. In order to provide the user a prediction of the seal condition, a transducer/sensor 67 in the grease packs 34, 44, from the front to the rear, monitors for pressure and temperature. Under normal operation, the pressure will have a predicted pressure differential as described in paragraph 2) above. Failures of the portions of the seal system will be detected with the monitoring equipment (not shown).
8. A guide bushing 24 at the rear helps hold the assembly concentric with the rotary tube 66, and also provides a method for pushing out the replaceable seal cartridge housing 22.
9. A canted coil spring 50 provides a positive retention of the seal system cartridge housing 22 into a seal housing 30.
10. O-rings 48 provide static sealing on the seal cartridge OD to prevent flow-around leakage.

With reference to FIG. 2b, there is shown the pressure gradient sealing system 20 with many of the character references not shown in order to more clearly illustrate the pressures areas and forces.

High pressure P1 pushes the floating extruder seal 46 until equilibrium is achieved with pressure P2 in the grease pack 44. Pressure P2 in the grease pack 44 produces a force F1 on a surface area A1 of the pressure reducing piston 38 which produces a force F2 over area A2 of an appropriate end of the pressure reducing piston 38, which provides a reduced pressure P3 on the rear grease pack 34. The pressure P3 activates the seal 32 at the reduced pressure P3 thereby providing lower PV and longer seal life.

A pressure transducer/temperature sensor 67 (FIG. 2a) is interconnected with the pressure ports 60, 64 for determining a pressure differential therebetween which, in turn, provides incipient seal failure detection as hereinafter discussed in greater detail.

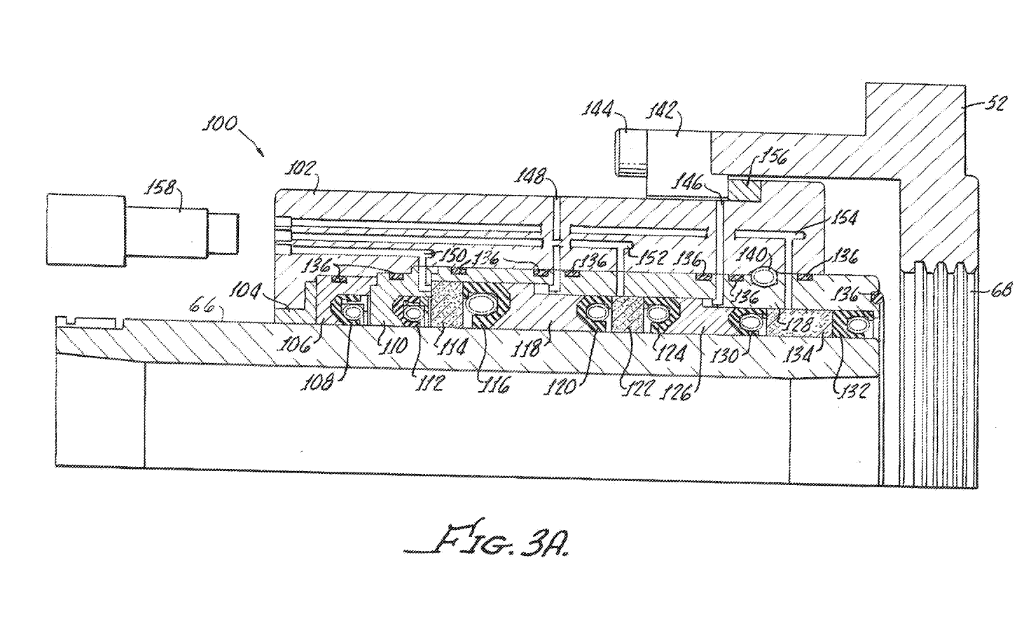

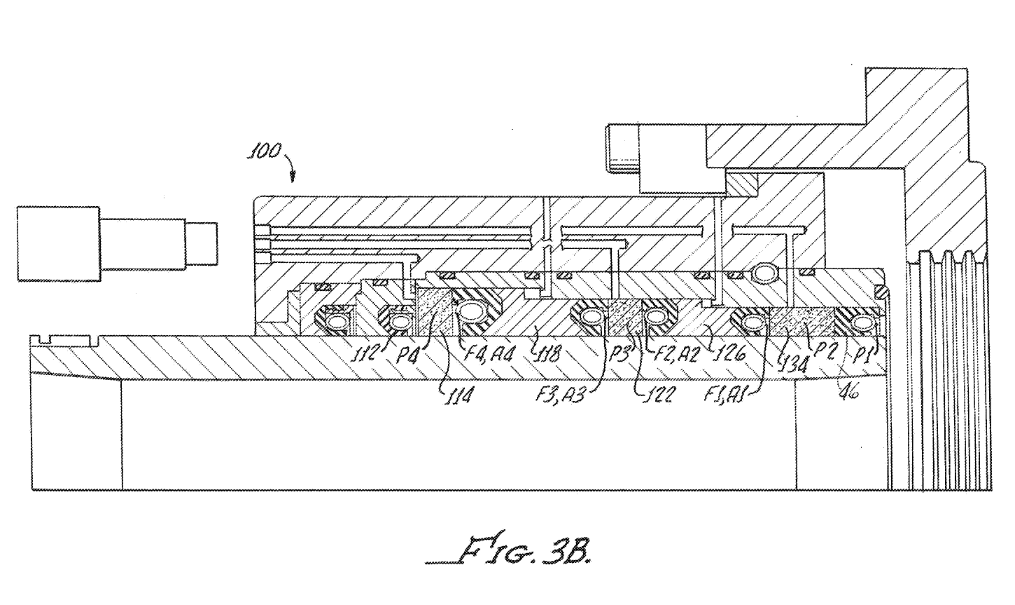

With reference to FIGS. 3a and 3b, there is shown a pressure gradient rotary sealing system 100 with two pressure reduction stages. The threaded ring 52 is coupled into a wash pipe tube 66 via threads 68, the tube 66 having drilling mud (not shown) flowing inside at high pressure. In this embodiment 100, a rear sealing cartridge assembly housing 102 is provided along with a guide bushing 104, a rear fixed seal housing 106, a rear fixed seal 108, a front fixed seal housing 110, and a front fixed seal 112.

A grease pack 114 is disposed between the front seal 112 and a rear seal 116 for a rear floating pressure reducing piston 118. A front seal 120 for the piston 118 abuts a middle grease pack 122 which, in turn, abuts a rear seal 124 for a front pressure reducing piston 126.

A cartridge housing 128 for the floating rear piston 118, and the front piston 126 is provided along with a front seal 130 separated from a front floating excluder seal 132 by a front grease pack 134.

As in the embodiment 100, a plurality of static system o-rings 136 are provided. A cartridge assembly retaining canted coil spring 140 is provided along with a locking ring 142 and locking bolt 144. A center vent 146 for the front floating piston 126 is provided along with a center vent port 148 for the floating piston 118.

A pressure port 150 for the rear grease pack 114 is provided along with a pressure port 152 for the middle grease pack 122 and a pressure port 154 communicates with the front grease pack 134. A tightening washer 156 is provided along with a pressure transducer 158, which is in communication with the pressure ports 150, 152, and 154 for determining pressure differential useful for determining seal life.

FIG. 3b shows the pressures, areas and forces for the pressure gradient rotary sealing system 100 with two-pressure-reducing stages. The pressure P1 pushes the floating extruder seal 46 to provide the pressure P2 in the front grease pack 134. Pressure on the grease pack P2 then produces a force F1 on a surface area A1 of the first pressure reducing piston 126. The force acting over the area A2 produces a reduced pressure P3, F2 which is the force acting over the area A2 producing a reduced pressure P3 in the middle grease pack 122. Pressure P3 on the middle grease pack 122 produces a force F3 on surface area A3 of the second pressure reducing piston 118. F4 is the force acting over the area A4 producing a further reduced pressure P4 in the rear grease pack 114. A pressure P4 thereafter activates the seal 112 with the further reduced pressure with resulting lower PV and longer seal life.

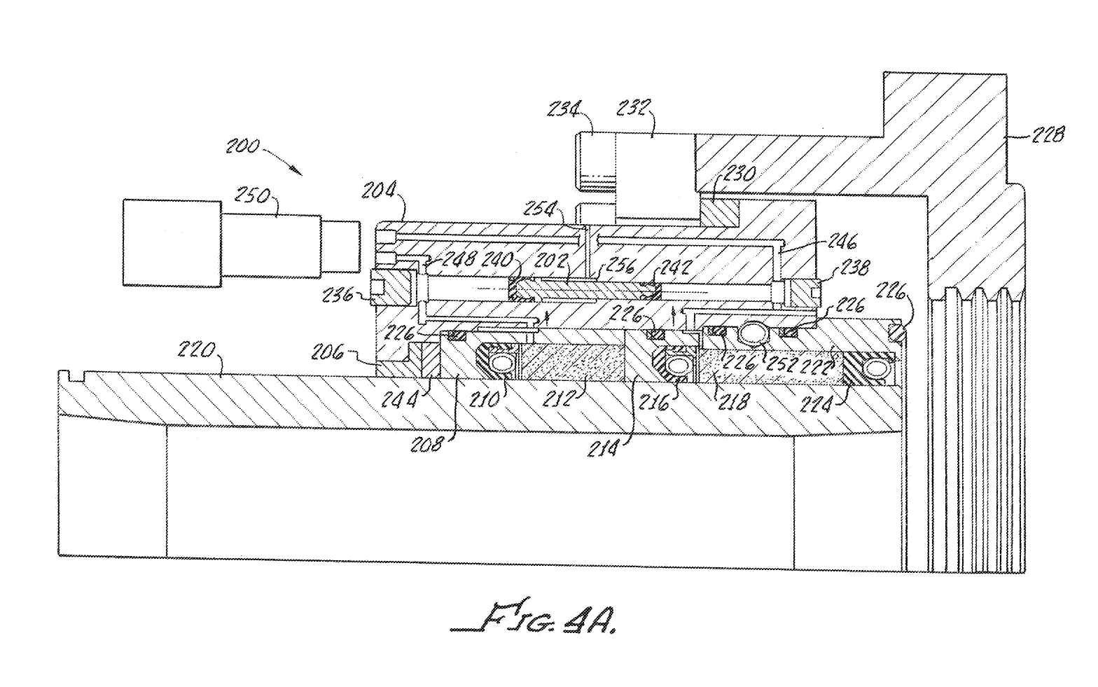

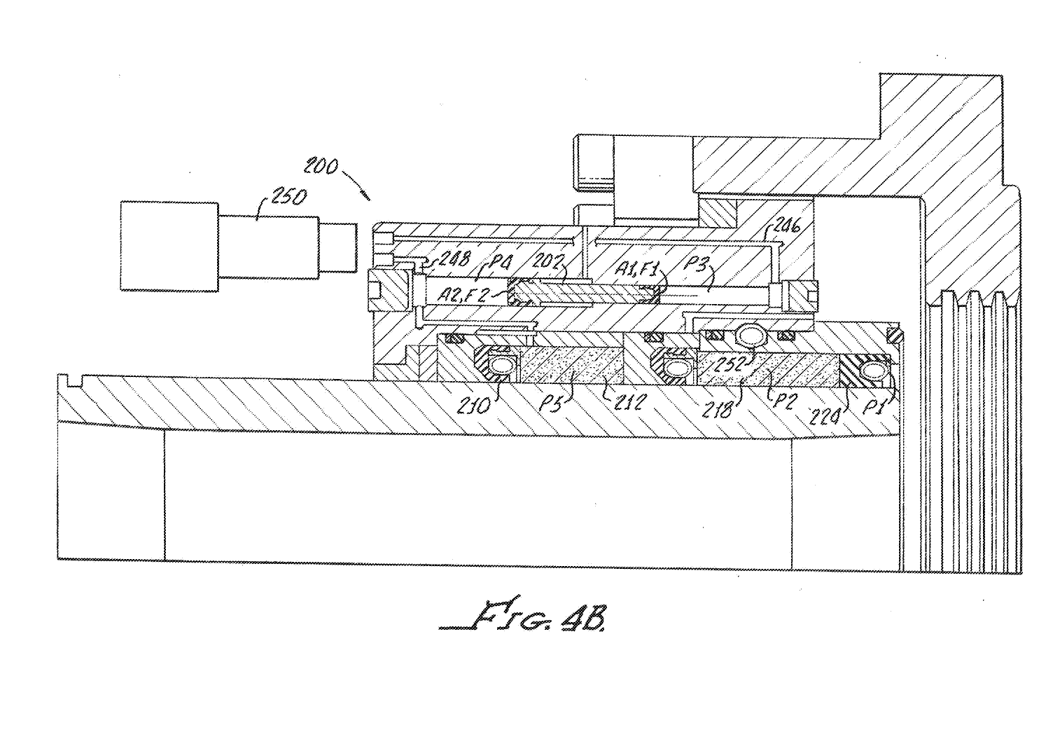

With reference to FIG. 4a, there is shown an alternative embodiment 200 of the pressure-gradient sealing system in accordance with the present invention utilizing a one or more side mounted pressure producing pistons 202.

More particularly, in this embodiment 200, a rear seal cartridge system housing 204 is provided along with a sealing system guide bushing 206/244, a rear seal support housing 208 along with a rear fixed seal 210.

A rear grease pack 212 is disposed between the rear fixed seal 210 and a center seal fixed-support housing 214 which abuts a center fixed seal 216 adjoining a front grease pack 218 which, in turn is disposed between a wash tube 220 and a sealing system cartridge housing 222. Also shown is a front floating extruder seal 224 along with a plurality of static o-rings 226.

Also shown in the FIG. 4a is a wash pipe attachment retaining threaded ring 228, a tightening washer 230, a tension ring 232, and retention-ring bolts 234.

Associated with the side mounted pressure reducing piston 202 is a rear cylinder plug 236 and a front cylinder plug 238, a rear cover seal 240, and a front cover seal 242.

Disposed between the guide bushing 206 and rear seal housing 208 is a spacer washer 204.

A front pressure port 246 and a rear pressure port 248 are provided and interconnected with a pressure transducer 250.

Also shown in FIG. 4a is a cartridge assembly retaining canted coil spring 252, and a vent port 254 disposed during a center 256 of the side mounted piston 202.

FIG. 4b shows pressures areas and forces for the sealing system 200 with the side mounted pressure producing piston 202. A pressure P1 on the excluder seal 224 pushes the seal 224 to produce an equilibrium pressure P2 in the front grease pack 218, i.e. P1=P2.

This pressure P2 is translated through the front pressure port 246 to a pressure P3 (P3=P2) against an area A1 of the piston 202 creating a force F1 through a change in diameter of the piston 202. The force F2 acting over the area A2 on the piston 202, produces a reduced pressure P4 which translates through the port 248 to a pressure P5, which is equal to pressure P4, on the grease pack 212 producing the reduce pressure P5 on the rear seal 210 thus providing longer seal life.

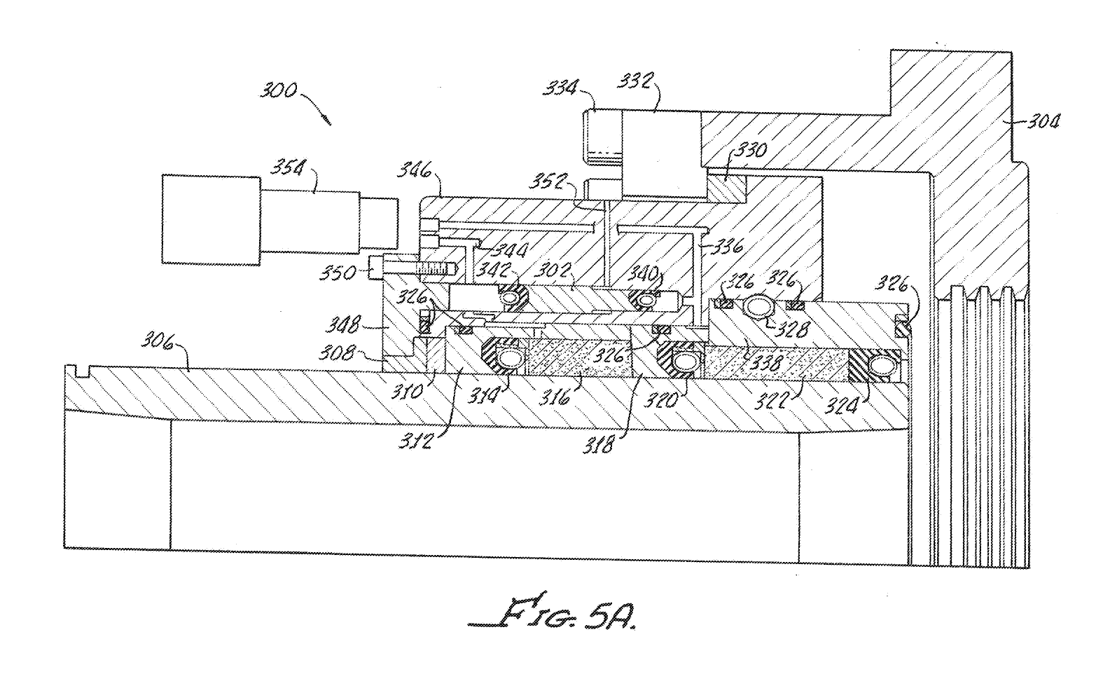

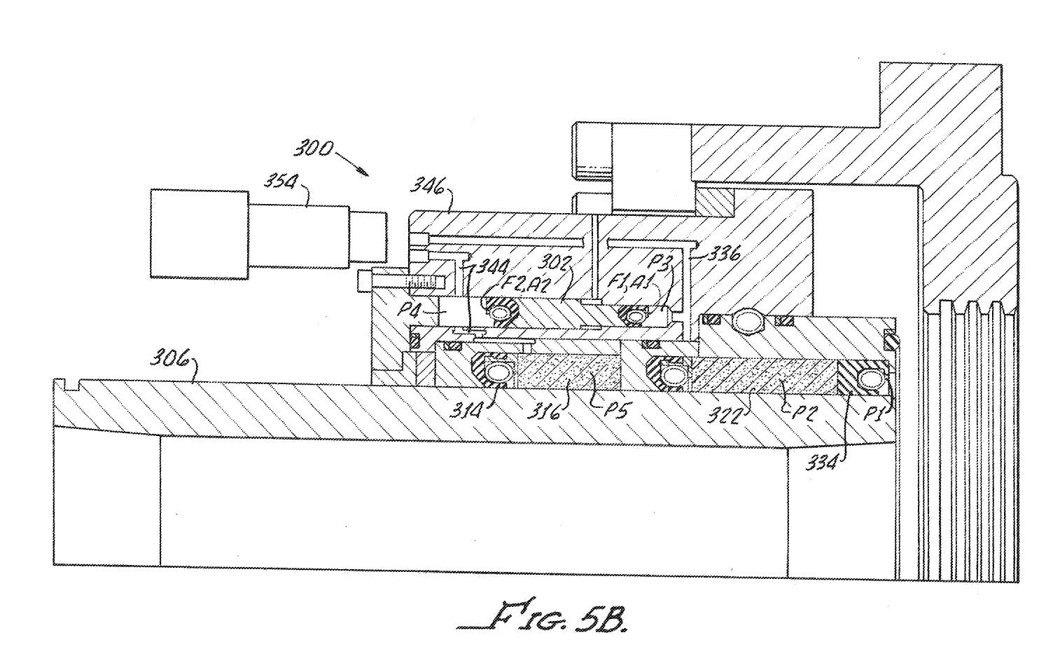

With the reference now to FIG. 5a, there is shown yet another embodiment 300 of a pressure-gradient rotary sealing system in accordance with the present invention utilizing an annular ring pressure-reducing piston 302 for a wash pipe attachment 304 having a wash tube 306.

As shown in FIG. 5a, the system 300 includes a seal system housing 346, a rear guide bushing 308, spacer washer 310, a rear seal housing 312 and a rear fixed seal 314 abutting a rear grease pack 316 which, in turn, abuts a center seal fixed port housing 318 and a center fixed seal 320. A front grease pack 322 is disposed between the fixed seal 320 and a front floating excluder seal 324.

As with previous embodiments 20, 100 and 200, the system includes a plurality of o-rings 326. Also, a sealing system cartridge retention canted coil spring 328 is provided along with a tightening washer 330, retaining ring 332, and retaining bolts 334.

A pressure port 336 is interconnected with the front grease pack 322, which is supported by a housing 338. A front seal 340, and a rear seal 342 are provided for the annular ring piston 302 and a rear pressure port 344 is provided for the rear grease pack 316, the port 344 being formed in a rear housing attached to a cylinder cap 348 by bolt 350. A vent 352 is provided for the piston 302 and both ports 336, 344 are interconnected with a pressure transducer 354.

FIG. 5b shows the pressures, areas, and forces for the pressure gradient rotary sealing system 300 shown in FIG. 5a. Pressure P1 pushes the excluder seal 324 to produce the pressure P2 in the front grease pack 322 with P1=P2.

The pressure P2 translated through the port 336 so that P2=P3. This produces a force F1 on the area A1 of the annular reducing piston 302 which then produces a force F2 acting on area A2 of the piston 302 to produce a reduced pressure P4 which is forwarded to the rear grease pack 316 and seal 314 through the port 344, producing a pressure P5 in the grease pack P5=P4.

This reduced pressure P5 provides for a longer seal life as hereinabove discussed. The pressure differentials is measured by a pressure transducer 346 similar to the embodiments hereinbefore described.

The purpose of the sealing system invention in accordance with the present invention is to provide a longer and more predictable seal-life solution to prevent fluid-media leakage through an interface between the sealing system 20, 100, 200, 300 and a wash pipe. The configuration illustrated in FIG. 2a sealing system includes of a two-piece housing. The pieces are held together during assembly by the retention canted-coil spring 50, FIG. 2. Five o-rings 48, FIG. 2a are used to block any leakage around the static periphery. The system 20 is mounted in place by the locking ring 56 and four locking bolts 58 tightening washer 54 which are used to prevent any distortion when the unit is assembled.

The floating excluder seal 46 prevents any media from entering the sealing system. Grease packs 34, 44 are used to lubricate the seals 32, 42 and to transfer the pressures as herein described earlier. Media pressure will push the floating excluder seal 46 against the grease pack 44 producing pressure, P1 shown in FIG. 2b. Pressure P1 acting against area A1 will produce a force F1 as shown in FIG. 2b.

The piston is a pressure-reduction piston that will move until forces F1 and F2 shown in FIG. 2b are in equilibrium. The front piston seal 42 exerts pressure P2 shown in FIG. 2b against the front of the pressure-reducing piston 38.

The pressure-reducing piston will move until forces F1 and F2 shown in FIG. 2b are in equilibrium. F1 is equal to P1×A1. P2 is equal to F2 divided by A2. Since A1 is less than A2, P2 will be less that P1. The ratio between P1 and P2 is directly proportional to the ratio between A1 and A2.

A 50% ratio between A1 and A2 will provide a 50% reduction in pressure from P1 to P2 resulting in a 50% reduction in PV for seal 32. Pressures P1 and P2 are measured by the pressure transducer 67 that is connected to the pressure ports 62, 64.

Note that the pressure-reducing piston 38 can move in either direction until the forces are in equilibrium. Under normal operations the pressure differential will remain constant. As the seals wear, grease will be extruded from the grease pack until the grease pack 34 volume approaches zero. As that happens the pressure differential will decrease indicating seal wear and a reduced seal life expectancy as the seal lubricate is extruded. Therefore this pressure differential value can be monitored and used as a tool to predict seal life.

With reference to FIGS. 3a and 3b, the pressure gradient pressure reduction system 100 can have multiple pressure reduction stages for further reductions in PV values. For example, FIG. 3a shows a system 100 with two pressure reduction stages produced by pressure-reducing pistons 118, 126. System pressures, areas, and forces are shown in FIG. 3b. The excluder seal 132 is a floating seal, so the pressure, P1 shown in FIG. 3b will be the same on both sides of the excluder seal 132. Due to the difference in area from the front to the rear of the pressure-reduction pistons 118, 126, pressure P2 will be less than P1, and P3 will be less than P2.

With reference to FIGS. 4a and 4b, a pressure reducing system 200 utilizes a side-mounted pressure-reducing piston 202, or multiple pistons 202, that can be spaced around a periphery of the system 200. Here the pressure-reduction piston, or pistons 202 have front areas, A1 as shown in FIG. 4b that are less than the rear area, A2 of the piston or pistons. The piston will move until the forces, F1 and F2 are in equilibrium. The pressure, P5 will be less than the pressure P2 thus reducing the seal PV for seal 216, 210 of FIG. 4a.

FIG. 5a shows a pressure gradient rotary seal system 300 with an annular ring pressure-reduction piston 302. Here again, the area difference between the front and the rear of the piston-seal will reduce the pressure P4 and P5 shown in FIG. 5b. The use of the annular ring-floating piston permits an increase in the volume of the grease pack without increasing the length of the sealing system.

It should be appreciated that a plurality of side mounted or annular pressure reducing pistons may be employed in accordance with the present invention.

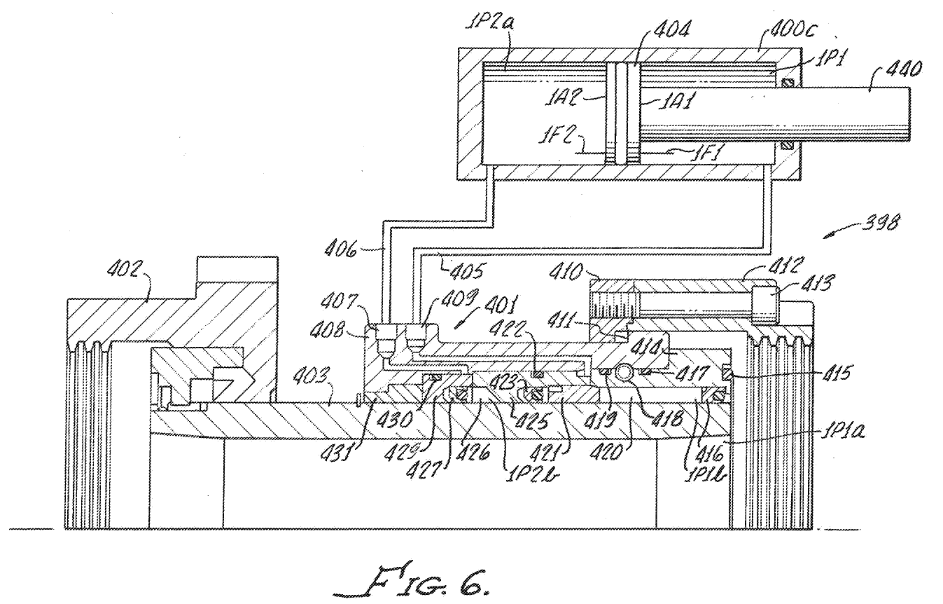

With reference to FIG. 6 sealing system 398 includes a wash pipe assembly 401, and the externally mounted pressure compensation cylinder 400 with piston 404. These assemblies are interconnected to a non-rotating top nut assembly 410 with fluid lines 405 and 406.

The wash pipe assembly 401 is made up of the major components comprising of the rotating wash pipe 403, a rotating lower seal nut assembly 402, and the multi-piece non-rotating top-nut assembly 410.

The positional support for the rotating wash pipe 403 is provided by soft metal bushings 431 and 421 mounting inside the non-rotating top nut assembly 408.

The top nut assembly 408 is held together during assembly by a retention canted-coil spring 418. O-rings 417, 419, 422, and 430 are used to block any leakage around the static periphery. The top nut assembly 408 is mounted in place by the locking ring 410 and locking bolts 413 in a top ring nut 412 and a tightening washer 411, which is used to prevent any distortion when the unit is assembled.

Tightening the top ring nut 412 with its large thread upon assembly pulls together tightly all of the following top nut internal components. The locking bolts 413, the locking ring 410, the tightening washer 411, the top nut assembly 408, the rear wash pipe guide bushing 431, a rear seal carrier 429, a center seal carrier 425, the center wash pipe guide bushing 421 and a front seal carrier 414. This all is pulled tight to seal with a static o-ring 415 against the counter surface face.

The three dynamic seals in the system are the floating excluder seal 416, the center pressure seal 423, and the rear pressure seal 427. Note that the pressure 1P1a, 1P1b and 1P1c are all equivalent when the system is in pressure equilibrium. Henceforth, these pressures can be referred to as specifically 1P1a, 1P1b, and 1P1c or generally as IP1. Likewise, the pressure 1P2a, 1P2b, and 1P2c are all equivalent when the system is in pressure equilibrium. Henceforth, these pressures can be referred to as specifically 1P2a, 1P2b, and 1P2c or generally as 1P2.

Since the pressure 1P2b is half of pressure 1P1b as described earlier, therefore seal 423 and seal 427 will only experience half the overall system pressure differential and therefore the seal system life will be significantly increased.

In operation, the front floating excluder seal 416, prevents any media from entering the sealing system. Grease packs 420 and 426 are used to lubricate the seals, and to transfer the pressures as described earlier. The media pressure 1P1a will push the front floating excluder seal 416 against the grease pack 420 producing pressure, 1P1b shown in FIG. 6. Pressure 1P1b transfers through port 409 and line 405 to external cyliner 400 creating pressure 1P1c. Pressure 1P1c acts against area 1A1 to produce a force 1F1 as shown in FIG. 6.

The pressure reducing piston 404 will move until forces 1F1 and 1F2 shown in FIG. 6 are in equilibrium. Force 1F1 is equal to pressure 1P1×area 1A1. Pressure 1P2 is equal to force 1F2 divided by area 1A2. Since area 1A1 is less than area 1A2, pressure 1P2 will be less that pressure 1P1. The ratio between pressures 1P1 and 1P2 is directly proportional to the ratio between the area 1A1 and 1A2.

A 50% ratio between 1A1 and 1A2 will provide a 50% reduction in pressure from 1P1 and 1P2 resulting in a 50% reduction in PV for seals 423 and 427. Pressures 1P1 and 1P2 can be measured by a pressure transducer, can also be connected to the pressure ports 407 and 409 for monitoring the system status and condition.

Further, the pressure differential across each pressure seal 423 and 427 is now reduced to half, therefore decreasing the Seal PV value and increasing significantly the expected seal life.

Note that he pressure-reduction piston 404 can move in either direction until the forces are in equilibrium. Under normal operations, the pressure differential between 1P1 and 1P2 will remain constant. As the seals wear, grease will be extruded from the grease pack 420 or 426 until the either grease pack volume approaches zero. The piston 404 will compensate for such grease loss and maintain the 1P1/1P2 pressure ration until it reaches the end of stroke. As this happens the pressure differential 1P1 to 1P2 will decrease indicating seal wear and a reduced seal system life expectancy as the seal lubricants and grease packs are depleted. Therefore, this pressure-differential value can be monitored and used as a tool to predict seal life. A piston shaft 440 visibly displays the parts of the piston head which provides a status of pressure balance and enabling determination system status, i.e. as to when the system 398 will need service.

Although there has been hereinabove described a specific pressure gradient rotary sealing system in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A system for providing sealing between a rotatable conduit, transporting a high pressure media, and a stationary member, said system comprising:
a housing disposable about said rotatable conduit;
an excluder seal disposable around said rotatable conduit and between said rotatable conduit and said housing, at a high pressure end of said system, for isolating said system from said high pressure media;
a center pressure seal disposed around said rotatable conduit and between said rotatable conduit and said housing;
a front grease pack disposed around said rotatable conduit and between said excluder seal and said front piston seal for equalizing pressure therebetween;
a rear pressure seal disposed around said rotatable conduit and between said rotatable conduit and housing; and
a pressure reducing piston disposed exterior to said housing and in communication with the center and rear pressure seals for reducing pressure on the center and rear pressure seals, said piston having a piston shaft visible for indicating system status.

2. A system for providing sealing between a rotatable conduit, transporting a high pressure media, and a stationary member, said system comprising:
a housing disposable about said rotatable conduit;
an excluder seal disposable around said rotatable conduit and between said rotatable conduit and said housing, at a high pressure end of said system, for isolating said system from said high pressure media;
a front piston seal disposed around said rotatable conduit and between said rotatable conduit and said housing;
a front grease pack disposed around said rotatable conduit and between said excluder seal and said front piston seal for equalizing pressure therebetween;
a rear piston seal disposed around said rotatable conduit and between said rotatable conduit and housing;
a pressure reducing piston disposed around said rotatable conduit and between said front piston seal and said rear piston seal for reducing pressure on said rear piston seal;
at least one fixed seal disposed around said rotatable conduit and proximate an atmosphere pressure end of said system; and
a rear grease pack disposed around said rotatable conduit and between said pressure reducing piston and the fixed seal.

3. The system according to claim 2 further comprises a plurality of piston seals, grease pack, pressure reducing pistons and fixed seals serially aligned in tandem with one another adjacent said excluder seal.

4. The system according to claim 2 further comprising a front pressure port in fluid communication with said front grease pack, a rear pressure port in fluid communication with said rear grease pack and a pressure transducer in fluid communication with both the fluid and rear pressure ports for determining a pressure differentiation therebetween in order to provide incipient seal failure detach.

5. The system according to claim 3 further comprising a pressure ports in fluid communication with each of the grease packs and a pressure transducer, in fluid communication with each port for determining a pressure differentiation therebetween in order to provide incipient seal failure detection.

6. A system for providing sealing between a rotatable conduit, transporting a high pressure media, and a stationary member, said system comprising:
a housing disposable about said rotatable conduit;
an excluder seal, disposable around said rotatable conduit and between said rotatable conduit and said housing, at a high pressure end of said system, for isolating said system from said high pressure media;
a front piston seal disposed around said rotatable conduit and between said rotatable conduit and said housing;
a front grease pack disposed around said rotatable conduit and between said excluder seal and said front piston seal for equalizing pressure therebetween;
a rear piston seal disposed around said rotatable conduit and between said rotatable conduit and housing;
a rear grease pack disposed around said rotatable conduit and adjacent said rear piston seal;
a front pressure port in fluid communication with said front grease pack;
a rear pressure port in fluid communication with said rear grease pack;
a side mounted pressure reducing piston interconnecting the front and rear pressure ports for lowering pressure said piston rear seal; and
at least one fixed seal disposed around said rotatable conduit and proximate an atmosphere pressure end of said system.

7. The system according to claim 6 further comprising a plurality of piston seals, grease packs, side mounted pressure reducing pistons and fixed seals, the seals, grease pack and fixed seals being aligned in tandem with one another between said excluder seal, each grease pack having an associated pressure port and each side mounted pressure reducing piston being disposed between pairs of ports.

8. The system according to claim 6 further comprising a pressure transducer in fluid communication with both the front and rear pressure ports for determining a pressure differentiation therebetween in order to provide incipient seal failure detach.

9. The system according to claim 7 further comprising a pressure transducer in communication with each of the grease packs and a pressure transducer in fluid communication with each port for determining a pressure differentiation therebetween in order to provide incipient seal failure detection.

10. A system for providing sealing between a rotatable conduit, transporting a high pressure media, and a stationary member, said system comprising:
a housing disposable about said rotatable conduit;
an excluder seal disposable around said rotatable conduit and between said rotatable conduit and said housing, at a high pressure end of said system, for isolating said system from said high pressure media;
a front piston seal disposed around said rotatable conduit and between said rotatable conduit and said housing;
a front grease pack disposed around said rotatable conduit and between said excluder seal and said front piston seal for equalizing pressure therebetween;
a rear piston seal disposed around said rotatable conduit and between said rotatable conduit and housing;
a rear grease pack disposed around said rotatable conduit and adjacent said rear piston seal;
a front pressure port in fluid communication with said front grease pack;
a rear pressure port in fluid communication with said rear grease pack;
an annular ring pressure reducing piston interconnecting the front and rear pressure ports for having pressure, said piston rear seal; and
at least one fixed seal disposed around said rotatable conduit and proximate an atmosphere pressure end of said system.

11. The system according to claim 10 further comprises a plurality of piston seals, grease packs, annular ring pressure reducing pistons and fixed seals, the seals, grease pack and fixed seals being aligned in tandem with one another between said excluder seal, each grease pack having an associated pressure port and each annular ring pressure reducing piston being disposed between pairs of ports.

12. The system according to claim 10 further comprising a pressure transducer in fluid communication with both the fluid and rear pressure pack for determining a pressure differentiation therebetween in order to provide incipient seal failure detach.

13. The system according to claim 11 further comprising a pressure transducer in fluid communication with each of the grease packs and a pressure transducer in fluid communication with each port for determining a pressure differentiate therebetween in order to provide incipient seal failure detection.
